(19) United States
(12) Patent Application Publication
(10) Pub. No.: US 2014/0024793 A1
(43) Pub. Date: Jan. 23, 2014

(54) POLYESTER PRODUCTION PROCESS AND APPARATUS

(71) Applicant: Hitachi, Ltd., Tokyo (JP)

(72) Inventors: Toshiaki MATSUO, Mito-shi (JP); Masayuki KAMIKAWA, Hitachinaka-shi (JP); Takeyuki KONDO, Hitachi-shi (JP); Norifumi MAEDA, Toshima-ku (JP)

(21) Appl. No.: 13/946,132

(22) Filed: Jul. 19, 2013

(30) Foreign Application Priority Data
Jul. 20, 2012 (JP) 2012-161856

(51) Int. Cl. C08G 63/80

(52) U.S. Cl. CPC C08G 63/80
USPC 526/270; 422/134

(57) ABSTRACT

Provided is a polyester production process which provides the polyester with a suitable molecular weight capable of enduring various mold processings and which can inhibit the polymer from being colored due to side reactions in synthesis.

The above polyester production process comprises:
an esterification step of carrying out an esterification reaction of ethylene glycol and 2,5-furandicarboxylic acid to form an oligomer and
a condensation polymerization step of carrying out a condensation polymerization reaction of the oligomer to produce polyester,
   wherein the esterification reaction is carried out at 200 to 250° C.

### CROSS REFERENCE TO RELATED APPLICATION

This application claims the foreign priority benefit under 35 U.S.C. §119 of Japanese Patent Application No. 2012-161856 filed on Jul. 20, 2012 in the Japanese Patent Office, the disclosure of which is herein incorporated by reference in its entirety.

### BACKGROUND OF THE INVENTION

1. Field of the Invention

The present invention relates to a polyester production process and an apparatus used for the same.

2. Description of the Related Art

Polyethylene terephthalate (hereinafter referred to as PET) is polyester prepared by using as principal raw materials, purified terephthalic acid (hereinafter referred to as PTA) which is a kind of dibasic acids and ethylene glycol (hereinafter referred to as EG) which is a kind of glycols. In recent years, polyesters originating in biomasses are paid attentions as alternative materials of general purpose plastics produced from petroleum-derived substances such as PET and the like from the viewpoint of extrication from dependence on oil. PET itself has the possibility that bio PET can be produced by synthesizing EG from bio ethanol and replacing PTA with an alternative substance originating in a biomass.

One example of a PTA alternative substance originating in a biomass includes 2,5-furandicarboxylic acid (hereinafter referred to as FDCA), and bio PET (hereinafter referred to as PEF (polyethylene•furandicarboxylic acid)) prepared by using the above substance has been researched and developed in recent years. PEF is synthesized, as explained below, by an esterification reaction of EG and FDCA and a condensation polymerization reaction of an oligomer (OLG) prepared by the above reaction.

An esterification reaction is a bonding reaction brought about between a carboxyl group of dibasic acid and an OH group of glycol at an atmospheric pressure, an applied pressure or a weakly negative pressure under an inert gas atmosphere of nitrogen and the like, and water is produced as a by-product (Formula 1). The above reaction is promoted by devolatizing and removing water produced. Also, a polymerization catalyst can be added, if necessary, in the above reaction, and the reaction is accelerated by the above operation.

In a condensation polymerization reaction, end glycol of one oligomer in oligomers produced by an esterification reaction under a reduced pressure environment and the presence of a polymerization catalyst is dissociated, and it is combined with end glycol of the other oligomer. Glycol is produced as a by-product of the above reaction (Formula 2), and the reaction is promoted by devolatizing and removing it, so that the polymerization degree is increased. A case in which the resulting PEF polymer (Polymer) has a molecular weight of 40,000 to 50,000 in terms of a weight average molecular weight is reported (non-patent document 1).

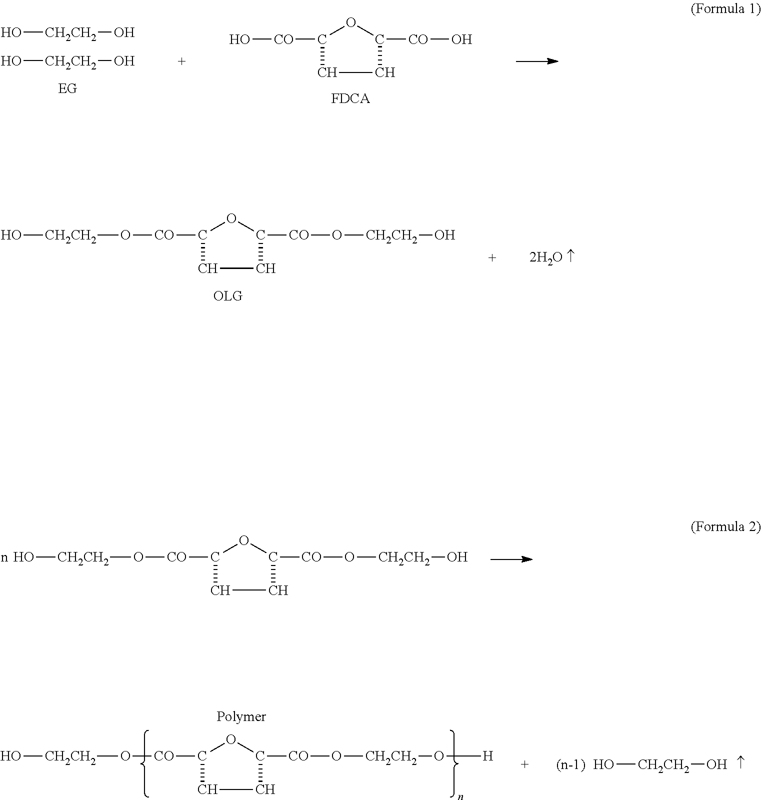

In respect to reaction conditions in PEF synthesis, an esterification reaction is carried out at a temperature of 75° C. for 6 hours using a small amount a hydrochloric acid catalyst under an atmospheric environment of an inactive atmosphere in the non-patent document 1. Then, after finishing the above reaction, a reduced pressure environment is created to devolatize and remove surplus EG and hydrochloric acid.

Also, in the non-patent document 1, a condensation polymerization reaction is promoted by gradually elevating the temperature from 75° C. to 215° C. (melting point of PEF) or higher using a polymerization catalyst (Sb₂O₃) under a reduced pressure environment.

In a patent document 1, an esterification reaction is carried out at a temperature of 150° C. or higher and lower than 200° C. by using a catalyst such as titanium tetrabutoxide and the like under an atmospheric environment of an inert atmosphere.

Further, in the patent document 1, a condensation polymerization reaction is promoted by treating the resulting oligomer at a temperature of 200 to 250° C. under a reduced pressure environment.

In the patent document 1, an upper limit temperature in the esterification reaction is set to 200° C. This is estimated to be because of the reason that since a boiling point of EG as a raw material in an atmospheric pressure environment is almost equivalent to the above temperature, a reduction in the raw material concentration caused by vaporization of EG is inhibited.

Also, in the patent document 1, an upper limit temperature in the condensation polymerization reaction is set to 250° C. The results of the experiments and investigations carried out by the present inventors show that this is understood to be reasonable for inhibiting coloration caused by thermal decomposition of the polymer chains. The coloration brought about in the above case originates usually in formation of a double bond between carbon atoms (Formula 3). The coloration of the polymers is the cause of damaging a beautiful appearance of the articles in processing the polymers to bottles, films, fibers and the like. Also, in dyeing clothes, it is difficult in a certain case to develop a suited color.

HO—{(CH₂)₂OCO(C₆H₄)OC}ₓ—O(CH₂)₂OH→HO—{(CH₂)₂OCO(C₆H₄)OC}_{y}—OH+HO—{(CH₂)₂OCO(C₆H₄)OC}_{x-y}—OCH═CH₂ (Formula 3)

In a patent document 2, an esterification reaction is carried out at a temperature of 165 to 185° C. by using a scandium triflate catalyst under an atmospheric environment of an inert atmosphere.

Further, in the patent document 2, a condensation polymerization reaction is carried out at a temperature of not higher than a melting point of PEF under a reduced pressure environment.

It is known that in addition to those described above, the side effect of causing the coloration of the reaction liquid is involved in the esterification reaction of PEF. In this regard, it is described in the patent document 2 that the coloration can not be inhibited in catalysts of a titanium base, an antimony base and the like which are usually used, and it is described therein that only when the scandium triflate catalyst is used, the respective reactions of esterification and subsequent condensation polymerization can be advanced while inhibiting the coloration. It is described therein as well that even in the above case, the esterification reaction temperature should not exceed 185° C.

### PRIOR ART DOCUMENTS

### Patent Documents

Patent document 1: JP-A 2011-132505
Patent document 2: JP-A 2009-215467

### Non-Patent Document

Non-patent document 1: Alessandro Gandini, et al., “The furan counterpart of poly(ethylene terephthalate): An alternative material based on renewable resources”, J. Polym. Sci., Part A, Vol. 47, p. 295-298 (2009).

As described above, involved therein are the problems that the coloration of the polymers is the cause of damaging a beautiful appearance of the articles in processing the polymers to bottles, films, fibers and the like and that in dyeing clothes, it is difficult in a certain case to develop a suited color. Accordingly, it is intensely desired by the industries concerned to establish techniques for inhibiting the polymers from being colored.

In the non-patent document 1, however, it is by no means described to inhibit the polymers from being colored in the esterification reaction and the condensation polymerization reaction, and the problems described above can not be solved.

Also, in the patent document 1, the side effect of causing the coloration of the reaction liquid can not be inhibited, and the problems described above can not be solved.

It is described in the patent document 2, as described above, that only when the scandium triflate catalyst is used, the respective reactions of esterification and subsequent condensation polymerization can be advanced while inhibiting the coloration. However, according to experiments and investigations thereof carried out by the present inventors, it has been confirmed that use of not only the scandium triflate catalyst but also triflate salts of bismuth and the like, and every catalysts of organic/inorganic titanium bases, an antimony base and an aluminum base can not inhibit coloration caused by an esterification reaction in a temperature range of 100 to 200° C. Also, an esterification reaction itself is promoted by an acid catalytic effect of FDCA itself without adding the catalyst, but it has been confirmed by experiments that the coloration is not inhibited as well under the above non-catalyst environment.

That is, in conventional technologies on polymerization of PEF, a reaction liquid has not been able to be inhibited from being colored due to a side reaction in an esterification reaction and a condensation polymerization reaction.

### SUMMARY OF THE INVENTION

The present invention has been made in light of the situations described above, and an object thereof is to provide a polyester production process which provides the polyester with a suitable molecular weight capable of enduring various mold processings and which can inhibit the polymer from being colored due to side reactions in synthesis, and an apparatus used for the above process.

The present invention for solving the problems described above relates to a polyester production process comprising:

an esterification step of carrying out an esterification reaction of ethylene glycol and 2,5-furandicarboxylic acid to form an oligomer and

a condensation polymerization step of carrying out a condensation polymerization reaction of the oligomer described above to produce a polyester,

wherein the esterification reaction described above is carried out at 200 to 250° C.

Further, the present invention relates to a polyester production apparatus comprising an esterification bath in which an esterification reaction of ethylene glycol and 2,5-furandicarboxylic acid is carried out to form an oligomer and a condensation polymerization reactor in which a condensation polymerization reaction of the oligomer described above is carried out to produce a polyester, wherein the esterification reaction described above is carried out at 200 to 250° C.

According to the present invention, capable of being provided are a polyester production process which provides the polyester with a suitable molecular weight capable of enduring various mold processings and which can inhibit the polymer from being colored due to side reactions in synthesis, and an apparatus used for the above process.

### BRIEF DESCRIPTIONS OF DRAWINGS

FIG. 1 is a flow chart showing the polyester production process according to one embodiment of the present invention.

FIG. 2 is a ¹H-NMR spectrum of the polymer sample (PEF) produced in the condensation polymerization reaction carried out using a titanium tetrabutoxide catalyst.

FIG. 3 is a ¹³C-NMR spectrum of the polymer sample (PEF) produced in the condensation polymerization reaction carried out using the titanium tetrabutoxide catalyst.

FIG. 4 is a graph showing a result obtained by experimentally determining a reaction velocity constant in the esterification reaction of the polymer sample (PEF) produced in the condensation polymerization reaction carried out by using the titanium tetrabutoxide catalyst. The horizontal axis shows the temperature (K), and the vertical axis shows the reaction velocity (m³/mol·ppm·s). In the drawing, the solid line shows an estimated value obtained from the Arrhenius plot, and the circle marks (∘) show the measured values obtained by the confirmation experiments.

FIG. 5 is a graph showing a result obtained by experimentally determining a reaction velocity constant in the condensation polymerization reaction of the polymer sample (PEF) produced in the condensation polymerization reaction carried out by using the titanium tetrabutoxide catalyst. The horizontal axis shows the temperature (K), and the vertical axis shows the reaction velocity (m³/mol·ppm·s). In the drawing, the solid line shows an estimated value obtained from the Arrhenius plot, and the circle marks (∘) show the measured values obtained by the confirmation experiments.

FIG. 6 is a block drawing showing the constitution of the polyester production apparatus according to one embodiment of the present invention.

FIG. 7 is a block drawing showing the constitution of the polyester production apparatus according to one embodiment of the present invention.

FIGS. 8A and 8B are drawings each showing an outline of a spectacle blade polymerization vessel which can suitably be used as a final polymerization vessel, wherein FIG. 8A is a cross-sectional view in a case where a stirring shaft is vertically cut, and FIG. 8B is a cross-sectional view in a direction parallel to the stirring shaft.

FIG. 9 is an explanatory drawing for explaining an outline of an experimental apparatus used for confirming the validity of the Arrhenius plot calculated.

FIG. 10 is a graph showing a result obtained by confirming the validity of the Arrhenius plot regarding the esterification reaction of the polymer sample (PEF) produced in the condensation polymerization reaction carried out by using the titanium tetrabutoxide catalyst. The horizontal axis shows the esterification time (h), and the vertical axis shows the reaction rate (%). In the drawing, the solid line shows an estimated value obtained from the Arrhenius plot, and the circle marks (∘) show the measured values obtained by the confirmation experiments.

FIG. 11 is a graph showing a result obtained by confirming the validity of the Arrhenius plot regarding the condensation polymerization reaction of the polymer sample (PEF) produced in the condensation polymerization reaction carried out by using the titanium tetrabutoxide catalyst. The horizontal axis shows the polymerization time (h), and the vertical axis shows the molecular weight×10⁴. In the drawing, the solid line shows an estimated value obtained from the Arrhenius plot, and the circle marks (∘) show the measured values obtained by the confirmation experiments.

### EXPLANATIONS OF CODES

S1: esterification step
S2: condensation polymerization step
1: FDCA supplying tank
2: EG supplying tank
3, 5, 7, 8, 10, 12, 14, 23, 28, 93: liquid supplying pumps
4: raw material mixing bath
6: slurry supplying bath
9: esterification bath
11: initial polymerization bath
13: intermediate polymerization vessel
15: final polymerization vessel
16. reflux column
17, 20, 25: cold traps
18, 21, 26: condensers
19, 22, 27: decompression devices
24, 29: coolers
30, 33, 36, 39: heating devices
31, 34, 37, 40: temperature measuring devices
32, 35, 38, 41, 44, 47, 50: heat transfer medium heating devices
42: controlling device
43, 46, 49: vacuum gauges
45, 48, 51: valves
52 to 61, 63 to 69, 72 to 74, 76, 79 to 80, 82 to 87, 90 to 92, 94 to 98, 105 to 106, 112: laying pipes
62, 70 to 71, 77 to 78, 81, 88 to 89, 99 to 102, 109: cables
103: polymer strand cooling bath
104: tip cutter
107, 108: catalyst supplying baths
4a, 6a, 9a, 11a, 13a, 110: stirring shafts
4b, 6b, 9b, 11b, 13b, 111: stirring blades

### DETAILED DESCRIPTION OF THE PREFERRED EMBODIMENT

A mode (embodiment) for carrying out the present invention shall be explained below with suitable reference to the drawings.

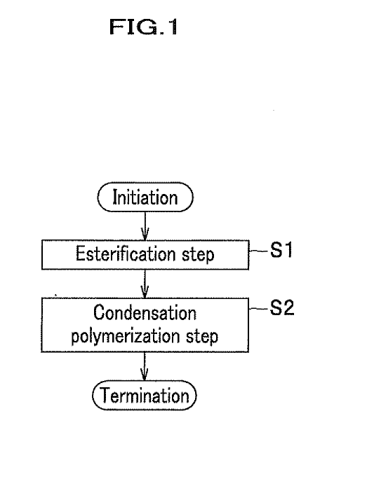

As shown in FIG. 1, the polyester production process related to one embodiment of the present invention comprises an esterification step S1 and a condensation polymerization step S2, and the above steps are carried out in this order.

In producing a polyester by applying the polyester production process of the present invention, the process may comprise a raw material mixing step (illustration omitted) of mixing raw materials prior to carrying out the esterification step S1 described above. Further, it may comprise a cooling step (illustration omitted) of cooling a liquid polyester after carrying out the condensation polymerization step S2 and a pelletizing step (illustration omitted) of pelletizing the cooled polyester by cutting and the like. The above raw material mixing step, cooling step and pelletizing step can be carried out on conditions on which the above steps are usually carried out.

### Esterification Step:

The esterification step S1 is a step in which an esterification reaction of ethylene glycol and 2,5-furandicarboxylic acid is carried out to form an oligomer. That is, in the esterification step S1, an end carboxyl group of FDCA is subjected to ester bonding to a hydroxyl group of EG by heating to form an oligomer having a hydroxyl group at an end.

In the present invention, the esterification reaction in the esterification step S1 is carried out at 200 to 250° C. This is because of the reason that the following knowledge has been obtained as the result of experiments and investigations carried out by the present inventors.

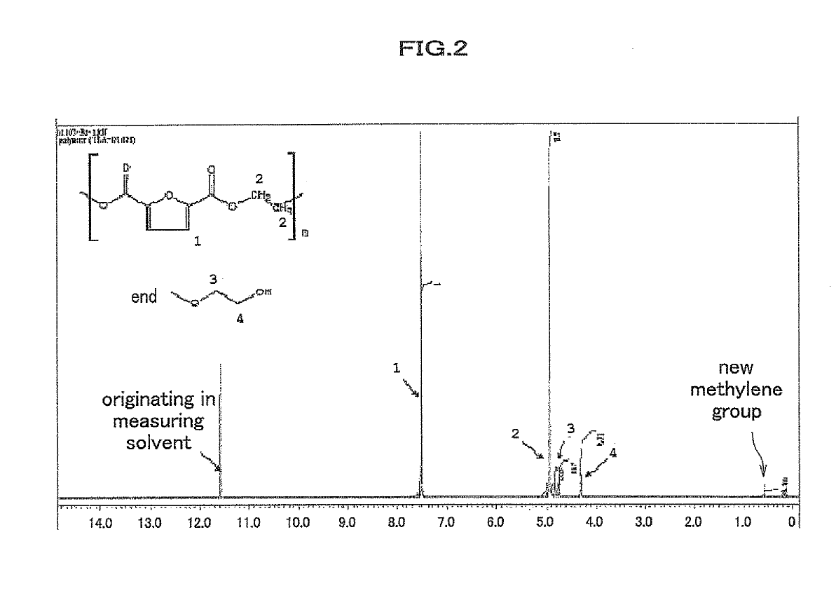

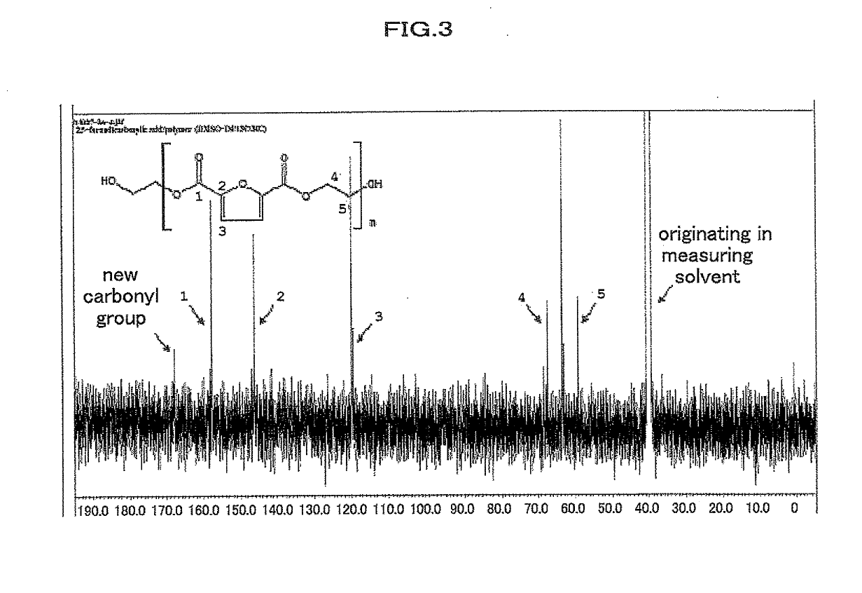

The polymer sample (PEF) formed by the condensation polymerization reaction using the titanium tetrabutoxide catalyst has been analyzed by NMR, and it has been confirmed, as shown in FIG. 2, from ¹H-NMR that a new methylene group (—CH₂—) which is not supposed to be present originally in the above polymer is formed. Also, it has been confirmed from ¹³C-NMR shown in FIG. 3 that similarly, a new carbonyl group (—CO—) is formed. The ¹H-NMR spectrum shown in FIG. 2 was measured at 500 MHz in a TFA (trifluoroacetic acid)-d₁ solvent, and the ¹³C-NMR spectrum shown in FIG. 3 was measured at 125 MHz in a DMSO (dimethyl sulfoxide)-d₆ solvent. In the respective drawings, resonance peaks shown by numerals (encircled numerals) surrounded by ∘ show protons or carbon skeletons shown by the same encircled numerals in the chemical formulas shown in the respective drawings.

Supposing that an influence caused by heat decomposition of the polymer chains is very small, a new carbonyl group can be formed only when an ether bond of the furan ring is cleaved in a molecular structure of the principal polymer. Also, only a new methylene group originating in EG is present in the system.

It has been considered from the above matters that a coloring mechanism in the esterification reaction is attributable to that an OH group of EG acts on an ether bond of FDCA to cleave it, whereby a double bond between carbon atoms is released from a furan ring of FDCA and arranged on the principal chain of the oligomer (Formula (4)).

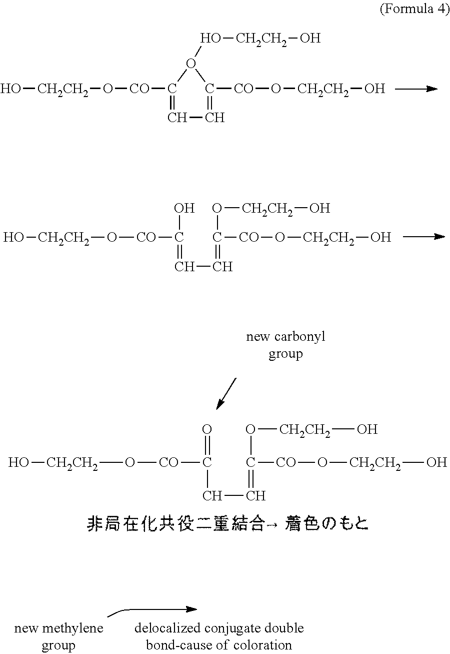

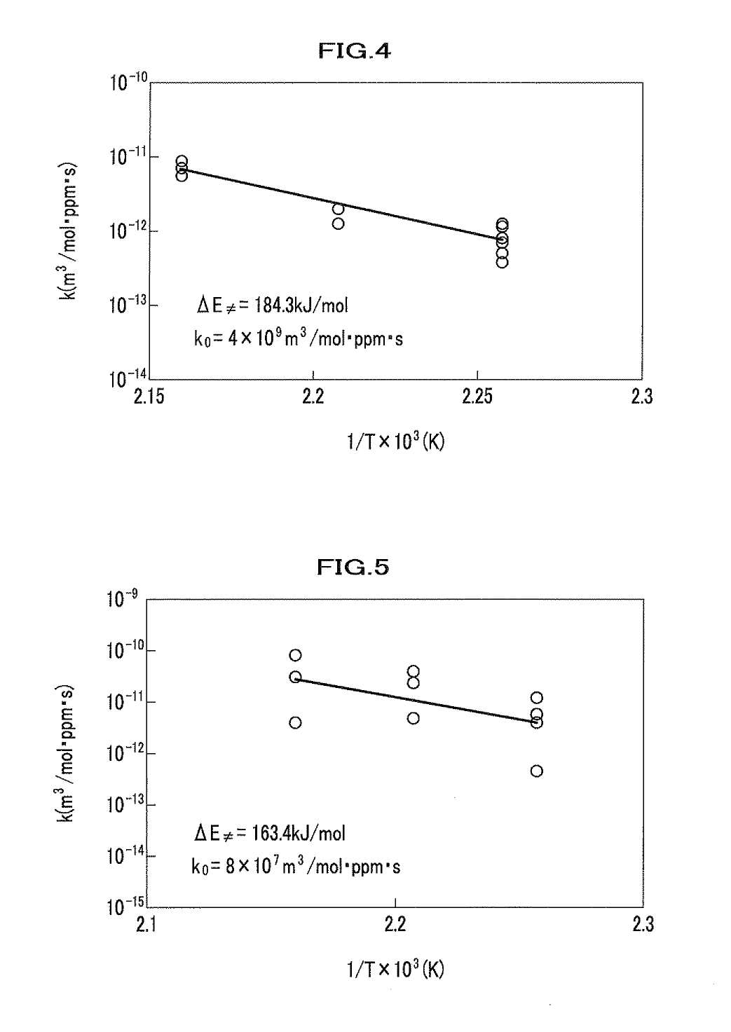

Also, the present inventors have found that since the ether bond cleavage reaction described above is a competitive reaction with the esterification reaction, there is the possibility that coloration can be inhibited by expediting relatively the esterification reaction. Then, a reaction velocity constant (K₀) in the esterification reaction of the polymer sample (PEF) formed by the condensation polymerization reaction carried out by using the titanium tetrabutoxide catalyst has been experimentally determined according to the Arrhenius plot to evaluate an activation energy (ΔE≠) thereof. As a result thereof, it has been evaluated, as shown in FIG. 4, to be 180,000 J/mol.

Also, a reaction velocity constant (K₀) in the condensation polymerization reaction of the polymer sample (PEF) formed by the condensation polymerization reaction carried out by using the titanium tetrabutoxide catalyst has been experimentally determined similarly according to the Arrhenius plot to evaluate an activation energy thereof (ΔE≠). As a result thereof, it has been evaluated, as shown in FIG. 5, to be 160,000 J/mol.

An activation energy of 180,000 J/mol in the esterification reaction is a considerably large value as compared with those in conventional chemical reactions. The present inventors have considered from the above matter that the esterification reaction carried out at a higher temperature makes it possible to inhibit relatively coloration caused in the esterification reaction, and they have found according to experiments that coloration caused in the esterification reaction is relatively reduced at a temperature of 200° C. or higher.

The item of [APPENDIX] is provided in a latter half of the present specification, and the Arrhenius plots of the esterification reaction and the condensation polymerization reaction and the activation energy are explained therein.

Also, when the reaction temperature exceeds 250° C., coloration caused by heat decomposition of the oligomer principal chain exerts gradually an influence as well in the esterification reaction as is the case with the condensation polymerization reaction (Formula 5).

HO—(CH₂)₂OCO(C₆H₄)OC—O(CH₂)₂OH→HO—(CH₂)₂OCO(C₆H₄)OC—OH+HOCH═CH₂ (Formula 5)

The above matter has caused the present inventors to reach the conclusion that the temperature of the esterification reaction has to fall, as described above, in a range of 200 to 250° C. Incidentally, vinyl alcohol present in a right side of the second line in Formula 5 is converted to aldehyde later.

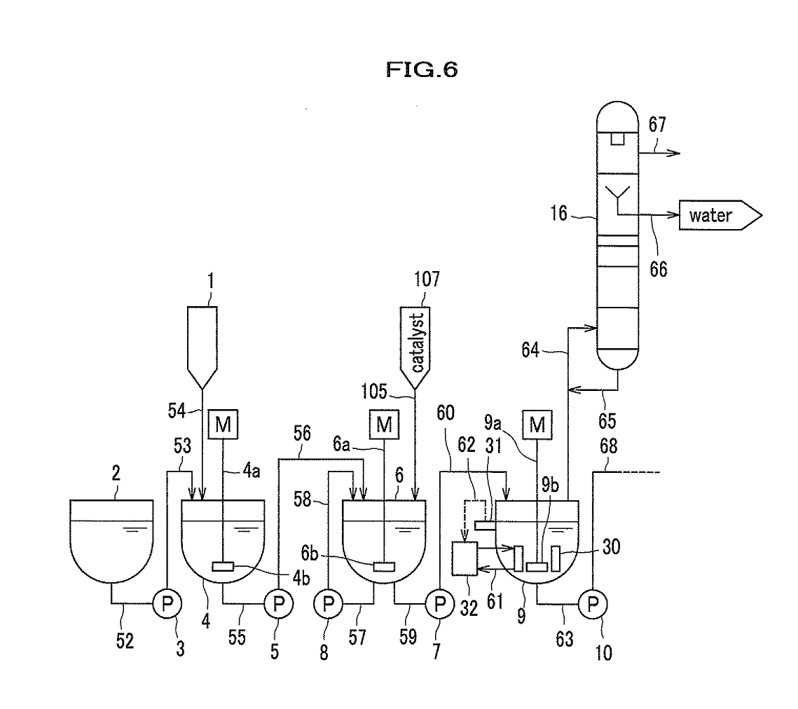

When the esterification reaction is carried out at a temperature of not lower than a boiling point of EG, in order to prevent volatilized EG from being discharged to the outside of the system and lost, EG has to be distilled from by-products (mainly water), condensed, separated and then circulated to the esterification bath. Positively vaporizing and circulating of EG makes it possible to maintain a concentration of EG esterified with FDCA to a relatively low level in the esterification bath 9 (refer to FIG. 6) and form an oligomer having a rather large polymerization degree. When the above oligomer is formed, the reaction is carried out preferably at an atmospheric pressure or lower, and it is carried out more preferably on a negative pressure condition. Also, the above condition provides the advantage that the oligomer can be avoided from being converted to a cyclic compound in the condensation polymerization step S2 to disturb the reaction. Further, a performance of removing water which is a by-product is enhanced by operation at a negative pressure side, and therefore involved therein is the advantage that a moisture concentration of the reaction solution is reduced and that the catalyst can be inhibited from being deactivated. The condition of a negative pressure and the circulation to the esterification bath shall be described later.

In contrast with this, the esterification reaction can be carried out as well on a pressurized condition. In this case, the steam pressure is relatively increased very much in a value as compared with a boiling point of EG. Accordingly, suitable selection of the pressure makes it possible to volatilize only water which is a by-product and allow EG volatilized at an atmospheric pressure to remain in a liquid phase. In the above case, involved therein are the advantages that leaking and losing of EG to an outside of the system which is caused by volatilization is inhibited and that the steps of distilling, condensing and circulating volatilized EG are not required. That is, the apparatus can be simplified, and the cost can be reduced. The conditions for pressurization shall be described later.

### Condensation Polymerization Step:

The condensation polymerization step S2 is a step in which the oligomer prepared in the esterification step S1 is subjected to condensation polymerization reaction and polymerized to produce a polyester (to be specific, PEF).

The condensation polymerization reaction is carried out preferably in a range of 215 to 250° C. in order to prevent PEF from being stuck in the polymerization vessel since a melting point of PEF is 215° C. The condensation polymerization reaction carried out in the above temperature range makes it possible to relatively reduce acting of an OH group at an end of the polymer onto an ether bond in the furan ring in the condensation polymerization step S2. The polyester (PEF) produced by the above condensation polymerization reaction is provided finally with, for example, a number average molecular weight of 40,000. Also, a b value of the above polyester is, for example, 4.

In the polyester production process explained above, the esterification step S1 and the condensation polymerization step S2 are carried out respectively on the conditions described above, whereby coloration caused by cleavage of the furan ring and coloration caused by heat decomposition of the principal chain are synergistically acted, and the degree of the coloration can be avoided from a situation in which it is notably increased. That is, the polymer can be inhibited from being colored due to side reactions in synthesizing the polyester (PEF). Also, the polyester having a suitable molecular weight capable of enduring various mold processings can be produced. According to the polyester production process of the present invention, a reduction in loss of EG, an increase in the recovery rates of the raw materials brought by simplification of the plant and a reduction in the facility cost make it possible to produce a plastic originating in a biomass at a lower cost. The above matters contribute to a reduction in the environmental load and resource saving. Also, the polyester produced by the above polyester production process can be applied to bottles, films, fibers and the like.

### Principal Constitution of Polyester Production Apparatus:

Next, the principal constitution of a continuous polymerization plant of polyester for carrying out the polyester production process according to one embodiment described above, that is, the polyester production apparatus shall be explained. In this connection, the continuous polymerization plant means a polymerization plant in which supplying of raw materials and discharging of a reaction liquid are carried out simultaneously and continuously in a steady state. Hereinafter, the continuous polymerization plant of polyester is referred to as the polyester production apparatus.

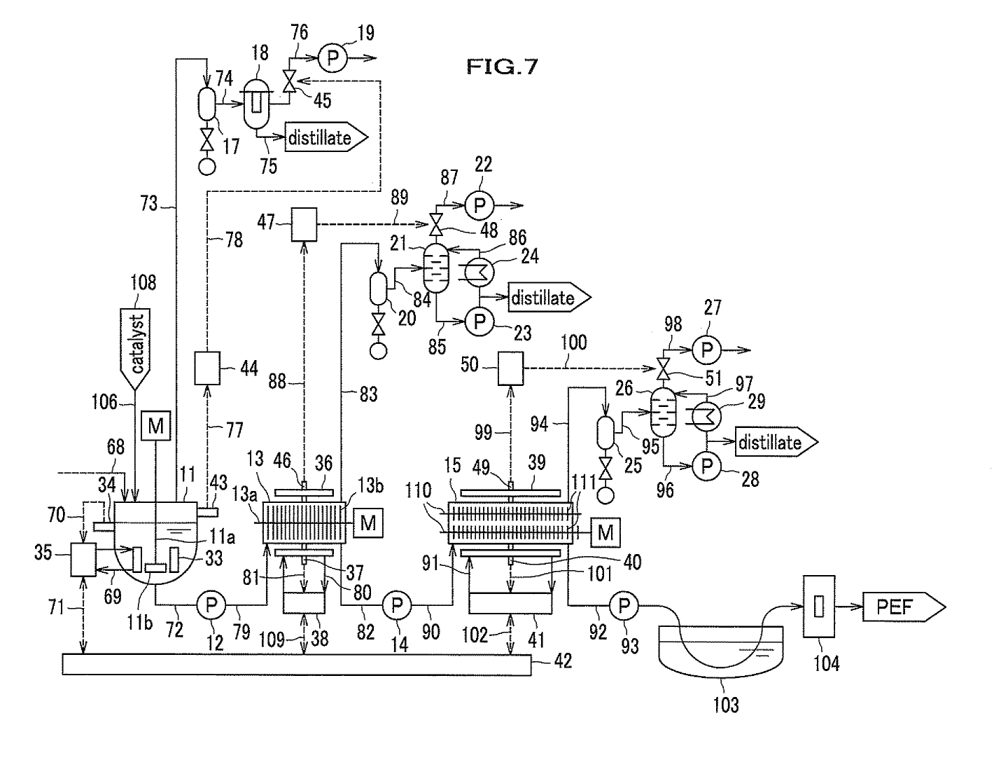

The principal constitution of the polyester production apparatus comprises at least an esterification bath (for example, an esterification bath 9 in FIG. 6) for carrying out the esterification step S1 and a condensation polymerization reactor (for example, an initial polymerization bath 11, an intermediate polymerization vessel 13 and a final polymerization vessel 15 in FIG. 7) for carrying out the condensation polymerization step S2.

### Esterification Bath:

The esterification bath is heated, as described above, to 200 to 250° C. to subject an end carboxyl group of FDCA to ester bonding with a hydroxyl group of EG, and an oligomer having a hydroxyl group at an end is formed.

A catalyst can be used, if necessary, in carrying out the ester bonding. The average polymerization degree of the oligomer formed does not necessarily have to be 1. Also, the targeted average polymerization degree is selected considering avoiding a loss of a reactivity of the raw materials caused by a cyclization reaction in a molecule of the oligomer, and the raw materials are mixed preferably at a mole ratio of FDCA/EG corresponding to the above polymerization degree. A mole ratio of FDCA/EG can be set to, for example, 2.0, but it shall not be restricted thereto.

### Condensation Polymerization Reactor:

The condensation polymerization reactor for polymerizing the oligomer formed in the esterification bath is divided usually into 2 to 3 stages according to a vacuum degree, and the reactor is constituted in a form in which they are connected in series. In the above case, a vacuum degree of the condensation polymerization reactor at a latter stage is set to a higher value, and this is attributable to that the amounts of by-products which are formed and devolatized according to the progress of the condensation polymerization reaction and EG and the concentrations thereof in the molten pre-polymer are gradually reduced. A partial pressure of EG is included in one factor of controlling devolatilization of EG, and when a concentration of EG is low, a partial pressure thereof is proportional to a concentration of EG in the molten polymer which is non-volatile according to a Henry law. In order to form bubbles of EG dissolved in the molten polymer, a partial pressure of EG has to be larger than a sum of a pressure exerted by a weight of the molten polymer itself applied onto the spot thereof and a pressure of the atmosphere (operating pressure). In order to compensate a reduction in a partial pressure thereof caused by a reduction in a concentration of EB in a latter stage of the condensation polymerization reaction, the operating pressure is reduced to prepare the atmosphere of a high vacuum degree, otherwise the devolatilization and the condensation polymerization reaction of EG do not proceed. Also, this shows that the devolatilization of EG takes place mainly in an interface between the molten pre-polymer and a space of an outside thereof, and dissolved EG is diffused and transferred from a bulk layer of the molten pre-polymer to the interface by a surface renewing effect brought about by stirring, whereby EG is liable to be devolatilized. An effect of stirring is reduced as the viscosity is elevated, and therefore it is important to select the process conditions and the equipments by anticipating the above situation.

As the condensation polymerization reaction proceeds, the pre-polymer is promoted to a higher polymer, and the molten pre-polymer is increased in a viscosity. In condensation polymerization of similar polyesters such as polyethylene terephthalate (PET) and polybutylene terephthalate (PBT), the polymerization temperature is usually elevated in proportion to the vacuum degree as the condensation polymerization reaction progresses. This is carried out in order to compensate a reduction in a concentration of the reaction end groups which results in a reduction in the reaction amount itself by an increase in the reaction velocity brought about by an elevation in the temperature, a rise in a partial pressure of glycol which is a by-product and an improvement in a surface renewing effect exerted by a reduction in the viscosity. When the pre-polymer reaches a high viscosity region in which the reaction is not accelerated even by above operations, a high viscosity polymerization vessel equipped with a double shaft stirring device which makes it possible to mix even a high viscosity fluid shall be used in the condensation polymerization reactor of the latter stage. In the above case, an upper limit of the polymerization temperature is preferably 250° C., as described above, from the viewpoint of inhibiting a heat decomposition reaction.

As described above, the condensation polymerization reactor is usually divided in many case into three stages of initial polymerization, intermediate polymerization and final polymerization in which high viscosity polymerization is carried out, or two stages of initial polymerization and final polymerization.

### Initial Polymerization Bath:

In the above case, a stirring device of a tank type is used usually for a polymerization vessel for initial polymerization (hereinafter referred to as an initial polymerization bath). A vacuum degree in the initial polymerization in PEF is set to preferably 667 Pa to 13.3 kPa (5 to 100 torr), more preferably 13.3 kPa to 26.6 kPa (10 to 20 torr). If the vacuum degree is elevated too much, devolatilization of EG progresses too rapidly, and EG is likely to be removed to an outside of the system more than necessary. In this case, a chance in which a part of carboxyl end groups formed by a reaction equilibrium is esterified is reduced, and it is not preferred in light of the quality (for example, an acid number and the like) of the finished polymer. Also, the initial polymerization is set preferably so that it accounts for 10 to 40% based on a whole polymerization time.

### Intermediate Polymerization Vessel:

A polymerization vessel having a single shaft stirring device of a lateral type is used usually for a polymerization vessel for intermediate polymerization (hereinafter referred to as an intermediate polymerization vessel) in many cases. The above polymerization vessel has stirring blades of a disc type and carries out mixing while increasing evaporation surfaces by formation of liquid films and a surface renewing effect in lifting a reaction liquid by the stirring blades and allowing it to fall freely. This accelerates by-products to be devolatilized. When handling a reaction liquid having a low viscosity, dams are provided usually in a polymerization reaction vessel to carry out treatment for improving a plug flow property. Also, when handling a reaction liquid having a considerably high viscosity, measures for elevating a tolerance viscosity to a higher level are taken in many cases by regulating the form of stirring blades and a setting method thereof. In a case of the polymer which is not necessarily increased in a viscosity, final polymerization carried out by using a high viscosity polymerization vessel can be omitted. A vacuum degree in the intermediate polymerization is set to preferably 133 Pa to 26.6 kPa (1 to 20 torr), more preferably 266 to 667 Pa (2 to 5 torr). Also, the intermediate polymerization is set preferably so that it accounts for 10 to 40% based on a whole polymerization time.

### Final Polymerization Vessel:

When a final viscosity is close to or exceeds 1 kPa·s, a high viscosity polymerization vessel of a lateral type having a double shaft stirring device is used preferably for a polymerization vessel for final polymerization (hereinafter referred to as a final polymerization vessel). The above polymerization vessel is operated usually in such a manner that the respective stirring shafts rotate in opposite directions to each other and that a molten polymer lifted by the stirring blade is stretched. This procedure increases an area of a devolatilization interface and expedites mixing of a high viscosity liquid by virtue of a repeating effect of stretching and folding. In the above case, the stirring blades mounted to the respective stirring shafts are brought into contact with the molten polymer adhered to the stirring shaft at an opposite side to tear it off, whereby the molten polymer is prevented from staying in the polymerization vessel for excessively long time and is reduced in an influence exerted by heat decomposition caused thereby. A vacuum degree in the final polymerization is set to preferably 266 Pa (2 torr) or less, more preferably 133 Pa (1 torr) or less. The typical lateral type polymerization vessel having a double shaft stirring device includes a spectacle blade polymerization vessel.

### Detailed Constitution of Polyester Production Apparatus and Production of Polyester:

Next, one example of the detailed constitution of the polyester production apparatus and the polyester produced by the above apparatus shall be explained with reference to FIG. 6 and FIG. 7. The polyester production apparatus shown in FIG. 6 and FIG. 7 comprises an esterification bath 9, an initial polymerization bath 11, an intermediate polymerization vessel 13 and a final polymerization vessel 15 as a principal constitution.

In the production of the polyester in the present invention, FDCA is supplied, as shown in FIG. 6, from an FDCA supplying tank 1 to a raw material mixing bath 4 via a laying pipe 54. Since FDCA is a powder, a screw feeder and the like can be preferably mounted as a means for supplying FDCA in a discharge port of the FDCA supplying tank 1 to control a supplying speed thereof. Also, EG is supplied from an EG supplying tank 2 to the raw material mixing bath 4 via laying pipes 52, 53 at a prescribed flow amount by means of a liquid supplying pump 3. EG is a liquid which is such a little viscous as about 0.1 Pa·s, and therefore various pumps such as a canned pump, a plunger pump and the like can be applied to the liquid supplying pump 3. The supplying speeds of FDCA and EG are determined so that a prescribed mole ratio thereof is obtained in the raw material mixing bath 4. An EG/FDCA mole ratio is usually 1 to 2.5, preferably 1.3 to 2.0. This is set for inhibiting a non-polymerizable reactive cyclic oligomer, particularly a trimer thereof from being formed in the esterification step S1 (esterification bath 9) of a latter stage.

EG and FDCA are mixed and turned into a slurry in the raw material mixing bath 4, and then the slurry is supplied to a slurry supplying bath 6 via laying pipes 55, 56 by means of a liquid supplying pump 5. In the slurry supplying bath 6, while the slurry supplied is mixed with a catalyst supplied from a catalyst supplying bath 107 via a laying pipe 105, a mixture (hereinafter, this is called as well a slurry) of the slurry and the catalyst is circulated continuously via laying pipes 57, 58 by means of a liquid supplying pump 8, and the slurry is discharged continuously to the esterification bath 9 via laying pipes 59, 60 by means of a liquid supplying pump 7. Various pumps such as a canned pump, a plunger pump and the like can be applied, as is the case with the liquid supplying pump 3, to the liquid supplying pumps 5, 7 and 8.

Two kinds of a solid catalyst and a liquid catalyst can be applied to the catalyst supplied. In the case of the solid catalyst, powders of oxides of titanium, germanium, antimony and the like are used in many cases, and titanium dioxide is particularly preferred from the viewpoint of a reactivity. When the solid catalyst is used, a screw feeder and the like can be preferably mounted as a means for supplying the catalyst in a discharge port of the catalyst supplying bath 107 to control a supplying speed thereof. On the other hand, in the case of the liquid catalyst, organic metals such as titanium, aluminum, zinc and the like are used in many cases, and titanium tetrabutoxide is particularly preferred from the viewpoint of a reactivity. When the liquid catalyst is used, a quantitative liquid supplying pump can be preferably mounted as a means for supplying the catalyst in a discharge port of the catalyst supplying bath 107 to control a supplying speed thereof. An addition amount of the catalyst is preferably 100 to 3000 ppm in terms of a titanium atom based on the slurry. It is pointed out as well that a case in which titanium dioxide is used exerts less influence of a heat degradation reaction on EG as compared with a case in which titanium tetrabutoxide is used, but to be basic, either of the solid catalyst and the liquid catalyst can be used.

The slurry is circulated by means of the liquid supplying pump 8 principally for the purpose of inhibiting solid-liquid separation from being caused in the slurry, but it can be omitted as well. Also, the raw material mixing bath 4, the laying pipes 55, 56 and the liquid supplying pump 5 can be omitted, if necessary, to supply EG and FDCA directly to the slurry supplying bath 6. In this case, the slurry supplying bath 6 is provided as well with a slurrying function of EG/FDCA.

The slurry is heated in the esterification bath 9 to the prescribed temperature range described above by means of a heating means 30 while stirred and mixed under an inert atmosphere of nitrogen and the like. The esterification bath 9 is preferably a stirring bath of a tank type. The esterification reaction of Formula 1 is brought about by the above operation, and a by-product formed, that is, water is vaporized in the slurry liquid to form bubbles and devolatilized. The steam devolatilized is sent to a reflux column 16 via a laying pipe 64 while accompanying partially EG and volatile low molecular weight oligomers. A pressure regulating device (not illustrated) for regulating a pressure of an inner gas phase is provided in the esterification bath 9. This makes it possible, as described above, to carry out the esterification reaction on a negative pressure condition or an applied pressure condition.

Separation is brought about in the reflux column 16 according to a difference in condensation temperatures, and EG and the oligomers having high boiling points are condensed and then returned to the esterification bath 9 via laying pipes 65, 64. Low boiling components comprising mainly steam are discharged to the outside of the system via a laying pipe 66. Thereafter, the discharged gas is usually condensed, and then it is subjected to waste water treatment such as biological treatment and the like and discharged to the outside of the system. The residual gas components left after removing the above components are discharged to the outside of the system via a laying pipe 67.

Various methods such as heating an inside or an outside of the bath by a heat exchanger and a heater, or combined use thereof can be applied as the heating means 30. In commercial plants, inner heat exchangers are used in many cases, and therefore this system shall be explained in the present embodiment.

A heating medium heated to a prescribed temperature by means of a heating medium heating device 32 is sent to the heating means 30 via a laying pipe 61, and the heating medium is circulated. The heating medium heating device 32 is provided with the function of enabling to set and regulate a temperature of the heating medium. A temperature measuring device 31 is mounted in the esterification bath 9, and it monitors a slurry temperature (reaction temperature) and transmits the result thereof to the heating medium heating device 32 via a cable 62. In the heating medium heating device 32, the above result is received to set and regulate a temperature of the heating medium so that a temperature of the slurry is controlled to a prescribed value.

The molten oligomer (hereinafter referred to merely as the oligomer) formed in the esterification bath 9 according to the reaction of Formula 1 is sent to an initial polymerization bath 11 shown in FIG. 7 via laying pipes 63, 68 by means of a liquid supplying pump 10. The oligomer sent via the laying pipes 63, 68 by means of the liquid supplying pump 10 is not a slurry and is a liquid, and therefore it does not involve the possibility of solid-liquid separation. In the esterification bath 9, it is carried out continuously to supply the slurry through the laying pipe 60 and discharge the oligomer through the laying pipe 63.

Process conditions in the esterification bath 9 are a pressure of 0.5 to 2.0 atm, a temperature of 200 to 250° C. and a residence time of 1 to 5 hours of the slurry. The laying pipes 63, 68 and the liquid supplying pump 10 are preferably heated and maintained as well at almost the same temperature as that of an inside of the esterification bath 9 in order to inhibit the oligomer from being solidified. Various pumps including a gear pump used for liquids having a higher viscosity as well as a caned pump, a plunger pump and the like can be applied, as is the case with the liquid supplying pumps 3 and 8, to the liquid supplying pump 10. When the process condition of the esterification bath 9 is a pressurized condition, a pressurizing device (pressure regulating device) for an inner gas phase is preferably provided in the esterification bath 9. On the other hand, when the process condition of the esterification bath 9 is an atmospheric pressure or lower, a decompression device (pressure regulating device) for an inner gas phase is preferably provided therein.

The oligomer sent through the laying pipe 68 is stirred and mixed, as shown in FIG. 7, with the catalyst supplied from a catalyst supplying bath 108 via a laying pipe 106 in an initial polymerization bath 11 in an inert atmosphere and a decompression atmosphere formed by a decompression device 19, and it is heated to the prescribed temperature described above by a heating means 33.

The initial polymerization bath 11 is preferably a stirring bath of a tank type. When the catalyst used in the esterification step S1 is not affected by deactivation and the like and sufficiently acts as well on the condensation polymerization reaction, the above catalyst is not necessarily required to be supplementarily added, and it can be omitted. This brings about the condensation polymerization reaction of Formula 2, and a by-product formed, that is, EG is vaporized in the oligomer to form bubbles and devolatilized.

Two kinds of a solid catalyst and a liquid catalyst can be applied to the catalyst supplied from the catalyst supplying bath 108, and the liquid catalyst is preferred from the viewpoint of a reactivity. In the case of the solid catalyst, powders of oxides of titanium, germanium, antimony and the like are used in many cases, and antimony oxide is particularly preferred from the viewpoint of a reactivity. When the solid catalyst is used, a screw feeder and the like can be preferably mounted as a means for supplying the catalyst in a discharge port of the catalyst supplying bath 108 to control a supplying speed thereof. On the other hand, in the case of the liquid catalyst, organic metals such as titanium, aluminum, zinc and the like are used in many cases, and titanium tetrabutoxide is particularly preferred from the viewpoint of a reactivity. When the liquid catalyst is used, a quantitative liquid supplying pump can be preferably mounted as a means for supplying the catalyst in a discharge port of the catalyst supplying bath 108 to control a supplying speed thereof.

Devolatilized EG is sent to a cold trap 17 via a laying pipe 73 while accompanying volatile low molecular weight oligomers. The low molecular weight oligomers are condensed and liquefied in the cold trap 17 according to a difference in a condensing temperature and separated from the gas phase, and an EG steam having a high boiling point is sent to a condenser 18 via a laying pipe 74. The condenser 18 may be a conventional indirect heat exchanging type condenser or a wet condenser, and in the present embodiment, the former is supposed and explained.

When accumulated in a prescribed amount, the liquefied low molecular weight oligomers are discharged to the outside of the system or returned as a part of the raw material to an upper stream side of the esterification bath 9 and the like and reused. EG is separated from the gas phase in the condenser 18 by condensing and liquefying it, and a residual gas component is discharged via a laying pipe 76 and the decompression device 19. Liquefied EG is stored in the form of a distillate via a laying pipe 75, and when accumulated in a prescribed amount, it is discharged to the outside of the system or returned to an upper stream side of the esterification bath 9 and the like and reused. Thereafter, the discharged gas is condensed, and then it is subjected preferably to waste water treatment such as biological treatment and the like and discharged to the outside of the system.

The decompression device 19 may be any of a vacuum pump, an ejector operated by a fluid, and the like. Various methods such as heating an inside or an outside of the bath by a heat exchanger and a heater, or combined use thereof can be applied to the heating means 33. In commercial plants, inner heat exchangers are used in many cases, and therefore this system shall be explained in the present embodiment.

A heating medium heated to a prescribed temperature by means of a heating medium heating device 35 is sent to the heating means 33 via a laying pipe 69, and the heating medium is circulated. The heating medium heating device 35 is provided with the function of enabling to set and regulate a temperature of the heating medium. A temperature measuring device 34 is mounted in the initial polymerization bath 11, and it monitors an oligomer temperature (reaction temperature) and transmits the result thereof to the heating medium heating device 35 via a cable 70. In the heating medium heating device 35, the above result is received to set and regulate a temperature of the heating medium so that a temperature of the slurry is controlled to a prescribed value.

A pre-polymer formed in the initial polymerization bath 11 according to the reaction of Formula 2 is sent to an intermediate polymerization vessel 13 via laying pipes 72, 79 by means of a liquid supplying pump 12. In the initial polymerization bath 11, it is carried out continuously to supply the oligomer through the laying pipe 68 and discharge the pre-polymer through the laying pipe 72.

A process condition in the initial polymerization bath 11 is preferably a vacuum degree of 667 Pa to 13.3 kPa (5 to 100 torr). If the vacuum degree is raised too much, devolatilization of EG proceeds quickly, and EG is likely to be removed to an outside of the system more than necessary. In the above case, a chance in which a part of carboxyl end groups formed according to a reaction equilibrium is esterified is reduced, and in light of the quality (for example, an acid number and the like) of the finished polymer, it is not preferred.

The initial polymerization bath 11 is provided with a vacuum meter 43 in order to regulate the vacuum degree to a prescribed value. The vacuum degree measured is transmitted to a regulating device 44 via a cable 77. In the regulating device 44, an opening degree of a valve 45 is controlled via a cable 78 according to the vacuum degree transmitted, whereby the vacuum degree is regulated. Also, a residence time of the oligomer in the initial polymerization bath 11, that is, a polymerization time in the initial polymerization is set to 1 to 4 hours. A polymerization temperature of the oligomer is set to 200 to 250° C., preferably 215 to 250° C. The laying pipes 72, 79 and the liquid supplying pump 12 are heated and maintained as swell at almost the same temperature as that of an inside of the initial polymerization bath 11 in order to inhibit the oligomer from being solidified. Various pumps including a caned pump, a plunger pump and a gear pump can be applied, as is the case with the liquid supplying pumps 3, 8 and 10, to the liquid supplying pump 12. The pre-polymer having a number average polymerization degree of 10 to 30 is formed by the initial polymerization.

The pre-polymer supplied through the laying pipe 79 is stirred and mixed in an intermediate polymerization vessel 13 in an inert atmosphere and a decompression atmosphere formed by a decompression device 22, and it is heated to a prescribed temperature by a heating means 36. The condensation polymerization reaction of Formula 2 is further expedited by the above operation, and a by-product formed, that is, EG is vaporized in the pre-polymer to form bubbles and devolatilized.

Devolatilized EG is sent to a cold trap 20 via a laying pipe 83 while accompanying volatile low molecular weight oligomers. The low molecular weight oligomers are condensed and liquefied in the cold trap 20 according to a difference in a condensing temperature and separated from the gas phase, and an EG steam having a high boiling point is sent to a condenser 21 via a laying pipe 84. When accumulated in a prescribed amount, the liquefied low molecular weight oligomers are discharged to the outside of the system or returned as a part of the raw material to an upper stream side of the esterification bath 9 and the like and reused. The condenser 21 may be a conventional indirect heat exchanging type condenser or a wet condenser. In the present embodiment, the wet condenser is supposed and explained.

A coolant stored at a bottom of the condenser 21 is sent to a top of the condenser 21 via laying pipes 85, 86 by means of a liquid supplying pump 23 and sprayed into an inside of the condenser 21. A cooler 24 is provided between the liquid supplying pump 23 and the laying pipe 86 to cool the coolant to a prescribed temperature or lower. Accordingly, the gas sent through the laying pipe 84 is brought into contact with the sprayed coolant in the condenser 21 and cooled, and EG is condensed and reaches the bottom of the condenser 21. When the condensed liquid (distillate) of EG is accumulated in a prescribed amount, it is discharged to the outside of the system or returned as a part of the raw material to an upper stream side of the esterification bath 9 and the like and reused. EG is separated from the gas phase in the condenser 21 by condensing and liquefying it, and the residual gas component is discharged via a laying pipe 87 and a decompression device 22. Thereafter, the discharged gas is condensed, and then it is subjected preferably to waste water treatment such as biological treatment and the like and discharged to the outside of the system. The decompression device 22 may be any of a vacuum pump, an ejector operated by a fluid, and the like. A temperature of cooling the coolant by the cooler 24 may be a temperature of such an extent that the gas sent through the laying pipe 84 can be cooled to condense EG.

Various methods such as heating an inside or an outside of the bath by a heat exchanger and a heater, or combined use thereof can be applied as the heating means 36. In commercial plants, outer heat exchangers (heating medium jackets) are used in many cases, and therefore this system shall be explained in the present embodiment.

A heating medium heated to a prescribed temperature by means of a heating medium heating device 38 is sent to the heating means 36 via a laying pipe 80, and the heating medium is circulated. The heating medium heating device 38 is provided with the function of enabling to set and regulate a temperature of the heating medium. A temperature measuring device 37 is mounted in the intermediate polymerization vessel 13, and it monitors a pre-polymer temperature (reaction temperature) and transmits the result thereof to the heating medium heating device 38 via a cable 81. In the heating medium heating device 38, the result thereof is received, and a temperature of the heating medium is set and regulated so that a temperature of the pre-polymer is controlled to a prescribed value.

The pre-polymer grown in the intermediate polymerization vessel 13 according to the reaction of Formula 2 is sent to a final polymerization vessel 15 via laying pipes 82, 90 by means of a liquid supplying pump 14. In the intermediate polymerization vessel 13, it is carried out continuously to supply the pre-polymer through the laying pipe 79 and discharge the pre-polymer through the laying pipe 82.

A process condition in the intermediate polymerization vessel 13 is preferably a vacuum degree of 133.3 Pa to 2.7 kPa (1 to 20 torr). The intermediate polymerization vessel 13 is provided with a vacuum meter 46 in order to regulate a vacuum degree to a prescribed value. The vacuum degree measured is transmitted to a regulating device 47 via a cable 88. In the regulating device 47, an opening degree of a valve 48 is controlled via a cable 89 according to the vacuum degree transmitted, whereby the vacuum degree is regulated.

Also, a residence time of the pre-polymer grown in the intermediate polymerization vessel 13, that is, a polymerization time in the intermediate polymerization is set to 1 to 4 hours. A polymerization temperature of the pre-polymer is set to 200 to 250° C., preferably 215 to 250° C. The laying pipes 82, 90 and the liquid supplying pump 14 are heated and maintained as well at almost the same temperature as that of an inside of the intermediate polymerization vessel 13 in order to inhibit the pre-polymer from being solidified. A gear pump which can meet a high viscosity fluid is preferably applied to the liquid supplying pump 14. A lateral polymerization vessel is applied as the intermediate polymerization vessel 13 in the present embodiment, but the range of the present invention shall not be restricted by it, and when a residence time of the oligomer is short, it may be the stirrer of a tank type used in the initial polymerization bath 11. The pre-polymer having a number average polymerization degree of 40 to 100 is formed by the intermediate polymerization.

The pre-polymer supplied through the laying pipe 90 is stirred and mixed in a final polymerization vessel 15 in an inert atmosphere and a decompression atmosphere formed by a decompression device 27, and it is heated to a prescribed temperature by a heating means 39. The condensation polymerization reaction of Formula 2 is further expedited by the above operation, and a by-product formed, that is, EG is vaporized in the pre-polymer to form bubbles and devolatilized. Devolatilized EG is sent to a cold trap 25 via a laying pipe 94 while accompanying the volatile low molecular weight oligomers. The low molecular weight oligomers are condensed and liquefied in the cold trap 25 according to a difference in a condensing temperature and separated from the gas phase, and an EG steam having a high boiling point is sent to a condenser 26 via a laying pipe 95. When accumulated in a prescribed amount, the liquefied low molecular weight oligomers are discharged to the outside of the system or returned as a part of the raw material to an upper stream side of the esterification bath 9 and the like and reused. The condenser 26 may be a conventional indirect heat exchanging type condenser or a wet condenser. A case of the wet condenser shall be explained in the present embodiment.

A coolant stored at a bottom of the condenser 26 is sent to a top of the condenser 26 via laying pipes 96, 97 by means of a liquid supplying pump 28 and sprayed into an inside of the condenser 26. A cooler 29 is provided between the liquid supplying pump 28 and the laying pipe 97 to cool the coolant to a prescribed temperature or lower. Accordingly, the gas sent through the laying pipe 95 is brought into contact with the sprayed coolant in the condenser 26 and cooled, and EG is condensed and reaches the bottom of the condenser 26. When the condensed liquid (distillate) of EG is accumulated in a prescribed amount, it is discharged to the outside of the system or returned as a part of the raw material to an upper stream side of the esterification bath 9 and the like and reused. EG is separated from the gas phase in the condenser 26 by condensing and liquefying it, and the residual gas component is discharged via a laying pipe 98 and a decompression device 27. Thereafter, the discharged gas is condensed, and then it is subjected preferably to waste water treatment such as biological treatment and the like and discharged to the outside of the system. The decompression device 27 may be any of a vacuum pump, an ejector operated by a fluid, and the like. A temperature of cooling the coolant by the cooler 29 may be a temperature of such an extent that the gas sent through the laying pipe 95 can be cooled to condense EG.

Various methods such as heating an inside or an outside of the bath by a heat exchanger and a heater, or combined use thereof can be applied as the heating means 39. In commercial plants, outer heat exchangers (heating medium jackets) are used in many cases, and therefore this system shall be explained in the present embodiment.

The heating medium heated to a prescribed temperature by means of a heating medium heating device 41 is sent to the heating means 39 via a laying pipe 91, and the heating medium is circulated. The heating medium heating device 41 is provided with the function of enabling to set and regulate a temperature of the heating medium.

A temperature measuring device 40 is mounted in the final polymerization vessel 15, and it monitors a pre-polymer temperature (reaction temperature) and transmits the result thereof to the heating medium heating device 41 via a cable 101. In the heating medium heating device 41, the result thereof is received, and a temperature of the heating medium is set and regulated so that a temperature of the pre-polymer is controlled to a prescribed value. The pre-polymer grown in the final polymerization vessel 15 according to the reaction of Formula 2 is sent to a polymer strand cooling bath 103 via a laying pipe 92 by means of a liquid supplying pump 93. In the final polymerization vessel 15, it is carried out continuously to supply the pre-polymer through the laying pipe 90 and discharge the polymer through a laying pipe 92.

A process condition in the final polymerization vessel 15 is preferably a vacuum degree of 266.6 Pa (2 torr) or less. The final polymerization vessel 15 is provided with a vacuum meter 49 in order to regulate a vacuum degree to a prescribed value. The vacuum degree measured is transmitted to a regulating device 50 via a cable 99. In the controlling device 50, an opening degree of a valve 51 is controlled via a cable 100 according to the vacuum degree transmitted, whereby the vacuum degree is regulated. Also, a residence time of the pre-polymer grown in the final polymerization vessel 15, that is, a polymerization time in the final polymerization is set to 1 to 4 hours. A polymerization temperature of the pre-polymer is set to 200 to 250° C. The laying pipe 92 and the liquid supplying pump 93 are heated and maintained as well at almost the same temperature as that of an inside of the final polymerization vessel 15 in order to inhibit the pre-polymer from being solidified. A gear pump which can meet a high viscosity fluid is preferably applied to the liquid supplying pump 93. The pre-polymer having a number average polymerization degree of 50 to 300 is formed by the final polymerization.

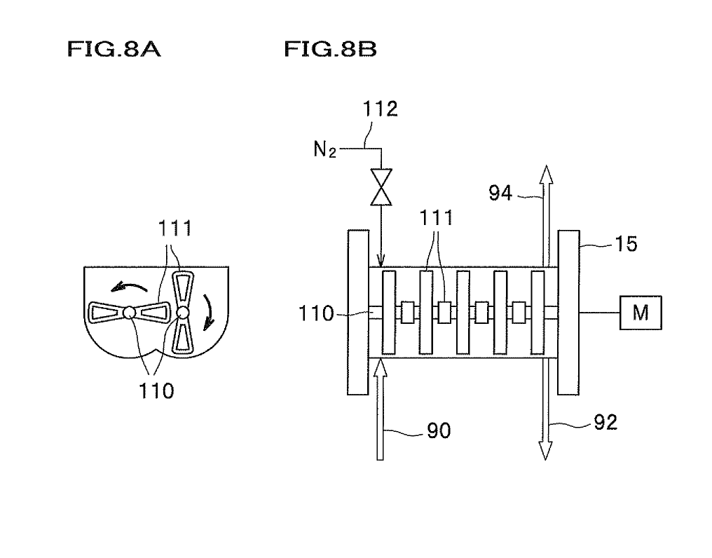

Since the pre-polymer is increased in a viscosity, a lateral polymerization vessel having a double shaft stirrer which can meet a high viscosity has to be used for the final polymerization vessel 15, and a typical vessel thereof includes a spectacle blade polymerization vessel manufactured by Hitachi Plant Technologies, Ltd. An outline of the spectacle blade polymerization vessel is shown in FIGS. 8A and 8B.

As shown in FIGS. 8A and 8B, the final polymerization vessel 15 is once substituted in a gas phase of an inside thereof with an inert gas (N₂ gas) via a laying pipe 112, and then it is exhausted and decompressed via a laying pipe 94. Two stirring shafts 110 are provided laterally to the ground and parallel to each other in an inside of the final polymerization vessel 15, and the respective stirring shafts 110 are provide with the prescribed number of stirring blades 111. The adjacent stirring blades 111 are provided at an angle in which a phase is shifted at 90°. Also, the stirring blades 111 are mounted on the same stirring shaft 110 while shifting a phase each at 90°. Two stirring shafts 110 are rotated in a direction opposite to each other, wherein a viscous fluid is lifted at a central part of a cross section in the final polymerization vessel 15, and it is stretched by the stirring blades 111; and then, the stretched viscous fluid is allowed to fall in a fluid storing part at a lower part of the final polymerization vessel 15 by virtue of a gravity. An effect exerted by an increase in an area of an interface of the fluid and a decrease in a thickness of the liquid film due to the above stretching accelerates the substances to be diffused and transferred from a fluid bulk layer to the interface. Also, a folding effect of the stretched fluid is involved in falling of the fluid by a gravity and subsequent stirring and mixing of the fluid by the stirring blades 111 in the fluid storing part at a lower part of the final polymerization vessel 15, and an action of diffusion and homogenization brought about by stirring and mixing is exerted on the fluid by the above effect. The by-product EG formed by the condensation polymerization reaction shown by Formula 3 is transferred from the pre-polymer bulk layer to the interface layer by the above effects of an increase in an area of an interface of the fluid, surface renewal and diffusing and mixing of the fluid, and it is devolatilized by evaporation in the interface and formation of bubbles to accelerate the condensation polymerization reaction.

In the heating medium heating devices 35, 38 and 41, the oligomer temperature in the initial polymerization bath 11, the pre-polymer temperature in the intermediate polymerization vessel 13 and the pre-polymer temperature in the final polymerization vessel 15 are set respectively. Also, the oligomer temperature in the initial polymerization bath 11, the pre-polymer temperature in the intermediate polymerization vessel 13 and the pre-polymer temperature in the final polymerization vessel 15 are transferred to the heating medium heating devices 35, 38 and 41, and the operation states can be confirmed. The above procedures make it possible to inhibit the polymer from being colored.

The respective liquid levels of the reaction liquids in the initial polymerization bath 11, the intermediate polymerization vessel 13 and the final polymerization vessel 15 are monitored usually by a liquid level meter (not illustrated in FIG. 7) of a dielectric constant system, a radial ray transmission system and the like. The liquid level meter is mounted usually so that a height of the reaction liquid in a vertical direction can be monitored in a position which is less liable to be affected by the stirrer, such as the vicinity of a discharge port of the reaction liquid, and the like. The respective liquid level meters provided in the initial polymerization bath 11, the intermediate polymerization vessel 13 and the final polymerization vessel 15 are connected with, for example, the regulating device 42 via the cable 70, the heating medium heating device 35 and the cable 71, or connected directly with the regulating device 42 via the cables 109, 102. The heights of the liquid levels monitored by the respective liquid level meters are designed so that they are transmitted to the regulating device 42 via the above device and cables. In the regulating device 42, the transmitted heights (residence amounts of the respective reaction liquids) of the respective liquid levels in the initial polymerization bath 11, the intermediate polymerization vessel 13 and the final polymerization vessel 15 are evaluated to regulate the heights of the respective liquid levels based a proportion of the polymerization times in the initial polymerization bath 11, the intermediate polymerization vessel 13 and the final polymerization vessel 15 in the condensation polymerization step S2. The above operation makes it possible to optimize the surface renewal effect and suitably promote the condensation polymerization reaction. The heights of the liquid levels can be regulated usually by changing a pressure difference by controlling the opening degrees of valves (omitted to illustrate) provided at the outlet laying pipes (laying pipes 72, 82, 92). Even in the above case, however, the liquid level can not be set to a lower level than a minimum height of the liquid level obtained when the opening degree of the valve is maximized.

The polymer discharged from the liquid supplying pump 93 is cooled with water in the polymer strand cooling bath 103 and then pelletized by means of a tip cutter 104, whereby the product polymer (PEF) is produced.

The raw material mixing bath 4, the slurry supplying bath 6, the esterification bath 9 and the initial polymerization bath 11 are provided respectively with motors M such as an engine, an electric engine, an internal combustion engine and the like. The motors M are connected with stirring shafts 4a, 6a, 9a and 11a and provided with stirring blades 4b, 6b, 9b and 11b at tips thereof. When the motors M are operated, the stirring blades 4b, 6b, 9b and 11b are rotated via the stirring shafts 4a, 6a, 9a and 11a, whereby the slurry and the pre-polymer can be stirred.

Also, the intermediate polymerization vessel 13 and the final polymerization vessel 15 each are provided as well with the same motors M. The motors M are connected respectively with stirring shafts 13a and 110 and provided with stirring blades 13b and 111 at tips thereof. When the motors M are operated, the stirring blades 13b and 111 are rotated via the stirring shafts 13a and 110, whereby the pre-polymer and the polymer can be stirred.

### Examples

### One Example of PEF Production

The polyester production apparatus shown in FIG. 6 and FIG. 7 to which the polyester production process as one embodiment of the present invention was applied was used to produce PEF. One example thereof is shown below. PEF was produced according to the following procedure and conditions.

First, EG and FDCA were mixed in a mole ratio EG/FDCA of 2.0 in the raw material mixing bath 4, and the resulting slurry was supplied to the slurry supplying bath 6. Titanium tetrabutoxide 2700 ppm was added as a catalyst in the slurry supplying bath 6, and after mixing them, the slurry was supplied to the esterification bath 9.

In the esterification bath 9, the slurry was estrified on the conditions of a pressure of 1.0 atm, a temperature of 230° C. and a slurry residence time of 40 minutes. As a result thereof, an oligomer which had an esterification rate of 95% and which was inhibited from being colored was obtained. The oligomer thus obtained was supplied to the initial polymerization bath 11.

In the initial polymerization bath 11, the catalyst was not supplementarily added to carry out polymerization on the conditions of a vacuum degree of 2.7 kPa (20 torr), a temperature of 240° C. and an oligomer residence time of 0.4 hour, and the pre-polymer was supplied to the intermediate polymerization vessel 13.

In the intermediate polymerization vessel 13, the polymerization was carried out on the conditions of a vacuum degree of 400 Pa (3 torr), a temperature of 240° C. and an oligomer residence time of 0.6 hour. As a result thereof, a pre-polymer having a weight average molecular weight of 21,000 was obtained. The pre-polymer thus obtained was supplied to the final polymerization vessel 15.

In the final polymerization vessel 15, the polymerization was carried out on the conditions of a vacuum degree of 133.3 Pa (1 torr), a temperature of 240° C. and a pre-polymer residence time of 0.6 hour. A lateral double shaft spectacle blade polymerization vessel (manufactured by Hitachi Plant Technologies, Ltd.) was applied as the final polymerization vessel 15.

The polymer thus obtained was cooled in the polymer strand cooling bath 103 and then pelletized by means of the tip cutter 104, and the pellets were used to carry out various analysises. As a result thereof, a polymer which had a number average molecular weight of 40,000 and a b value of 4 and which was inhibited from being colored was obtained.

The content of the present invention has been explained above in detail according to the embodiment for carrying out the invention, but the present invention shall not be restricted to the content described above and includes various modified examples thereof. For example, the embodiments described above have been explained in detail so as to make the present invention clearly understable, and it shall not necessarily be restricted to the inventions provided with all the constitutions explained above. Also, a part of the constitution of one embodiment can be substituted with the constitution of the other embodiment, and the constitution of one embodiment can be added as well to the constitution of the other embodiment. Further, it is possible to add, delete and substitute a part of the constitutions of the respective embodiments for the other constitutions.

A part or all of the respective constitutions, functions, treating parts, treating means and the like each described above may be materialized by hardwares, for example, by designing with integrated circuits. Also, the respective constitutions, functions and the like each described above may be materialized with softwares by causing processors to interpret programs actualizing the respective functions and carrying out them. Informations of the programs actualizing the respective functions, tables, files and the like can be put in recording devices such as memories, hard discs, SSD (solid state drive) and the like or recording media such as IC cards, SD cards, DVD and the like.

Also, control lines and information lines which are considered to be necessary for explanations are shown, and all control lines and information lines required for the products are not necessarily shown. In fact, almost all the constitutions may be considered to be connected with each other.

### APPENDIX

The Arrhenius plots of the esterification reaction and the condensation polymerization reaction, the activation energy and the like shall be explained below.

### [1] Preparation of Arrhenius Plot and Confirmation Experiments Therefor in Esterification Reaction:

First, esterification reaction experiments in a test tube scale were carried out at various temperatures to obtain a change of an esterification rate thereof with the passage of time. Then, the reaction speed constants were calculated from the results thereof (refer to FIG. 4) to obtain the Arrhenius plot of the esterification reaction by settling a dependency on temperature.

Next, one combination of the conditions of the esterification reaction was selected from the Arrhenius plot obtained, and experiments in a flask scale were carried out to obtain a change of an esterification rate with the passage of time and confirm an integrity thereof with theoretical forecast. The details thereof are described below.

The esterification reaction experiments in a test tube scale were carried out on conditions shown in Table 1, wherein EG and FDCA which were the raw materials and titanium tetrabutoxide which was the catalyst were added to the test tube, and glass joints for a nitrogen supplying system (1 atm) and a discharge system of a by-product (steam) gas were mounted to an upper part of the test tube. Then, the above test tube was inserted into a commercial block heater test equipment and heated at a prescribed temperature for prescribed time each shown in Table 1. The sample was recovered from the test tube after finishing heating, and prescribed analysis was carried out to analyze the data thereof, whereby the reaction speed constant was calculated. A chemical formula regarding the esterification reaction of EG and FDCA is shown in Formula 6.

TABLE 1

| Items | Conditions |
|---|---|
| EG/FDCA mole ratio | 9 |
| FDCA addition amount | 1 g |
| Temperature | 170 to 190° C. |
| Reaction time | 0 to 4 hours |
| Catalyst concentration | 1250 to 5000 ppm/FDCA |

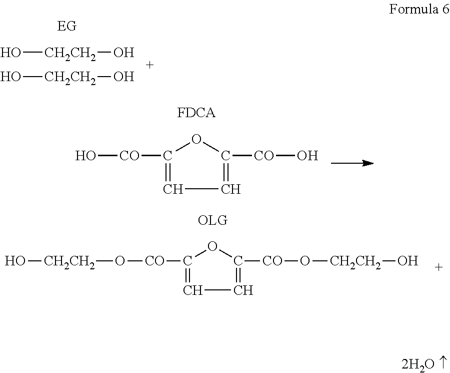

The recovered sample was analyzed by acid number quantitative analysis in which a carboxyl group was quantitatively determined by titration. The above analysis was carried out in the following procedure.

Pyridine or benzyl alcohol was added to the sample to dissolve it, and then after bromothymol blue•phenol red which was an indicator was added thereto, the mixture was subjected to indicator titration with a 0.1N-KOH ethanol solution. The value of the acid number obtained and Formula 7 were used to calculate an acid concentration [COOH] which was a concentration of a carboxyl group contained in the reaction solution.

[COOH]=(acid number of sample)/(molecular weight of KOH:56.1)×1000 Formula 7

The esterification rate can be calculated from the value of [COOH] and Formula 8.

Esterification rate=1−([COOH] of sample)/([COOH] of raw material) Formula 8

The reaction speed constant can be calculated according to the following way of thinking by using the value of [COOH] obtained above. Simplification of Formula 6 makes it possible to consider that it is shown that one of hydroxyl groups of EG is subjected to dehydration condensation with one of carboxyl groups of FDCA in the esterification reaction.

[COOH]+[OH]→[H₂O]↑ Formula 9

Accordingly, assuming that a distillation amount of EG is very small, a hydroxyl group concentration [OH]ₜ₊_{^{Δt}} contained in the reaction solution after time Δt passes based on time t can be calculated sequentially from an initial value according to Formula 10 using [COOH]ₜ₊_{^{Δt}}.

[OH]ₜ₊_{^{Δt}}=[OH]ₜ—([COOH]ₜ—[COOH]ₜ₊_{^{Δt}}) Formula 10

In the above case, assuming that the esterification reaction is a primary reaction, a rate equation on [COOH]ₜ corresponding to Formula 9 is set up, and taking Formula 10 into consideration with the above equation, a governing equation is derived (Formula 11).

$$\begin{matrix}\frac{d [ COOH ]}{d ΔΔ} = - k [ COOH ] [ OH ] \\ = \frac{d [ OH ]}{d ΔΔ} \\ = - {k [ COOH ]}_{t} \cdot \{ {[ OH ]}_{t} - \\ ( {[ COOH ]}_{t} - {[ COOH ]}_{t + Δ t} ) \}\end{matrix} \qquad Formula 11$$

Formula 11 can be integrated with time, and an acid concentration [COOH]ₜ₊_{^{Δt}} after time t+^{Δt} passes is correlated to Δt according to the following Formula 12.

$$ln \frac{{[ COOH ]}_{t\_Δ t} \cdot {[ OH ]}_{t}}{{[ COOH ]}_{t} \cdot ( {[ COOH ]}_{t + Δ t} + {[ OH ]}_{t} - {[ COOH ]}_{t} )} = \frac{k}{{[ OH ]}_{t} - {[ COOH ]}_{t}} Δ t \qquad Formula 12$$

Formula 12 can be changed to the following Formula 13.

$$k = \frac{{[ OH ]}_{t} - {[ COOH ]}_{t}}{Δ t} \cdot ln \frac{( {[ COOH ]}_{t + Δ t} + {[ OH ]}_{t} - {[ COOH ]}_{t} ) \cdot {[ COOH ]}_{t}}{{[ COOH ]}_{t + Δ t} \cdot {[ OH ]}_{t}} \qquad Formula 13$$

In Formula 13, k can be determined from the values of [OH]ₜ, [COOH]ₜ and [COOH]ₜ₊_{^{Δt}}, and this can be assumed to be proportional usually to a catalyst concentration [cat] in PET, PBT and the like, so that the reaction speed constant ke was calculated according thereto (Formula 14).

k_{E}=k/[cat] Formula 14

The value of k_{E} obtained was settled to 1/T to thereby prepare an Arrhenius plot, and the activation energy and the frequency factor were calculated from the values of a gradient obtained by a least square method and an intercept. T shows an absolute temperature (Kelvin (K)).

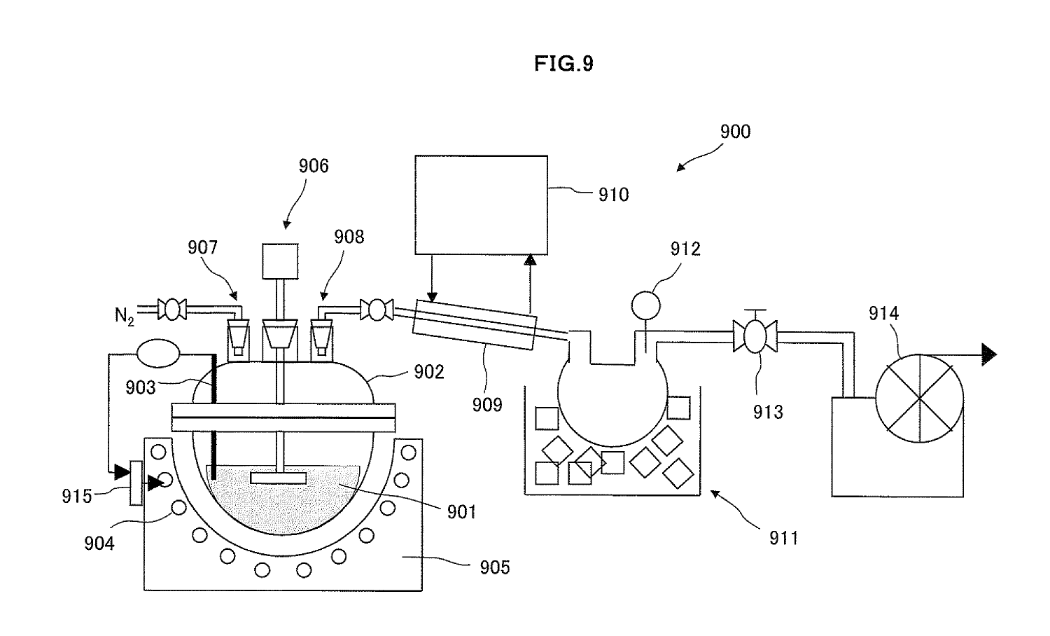

Confirmation experiments in a flask scale were carried out in order to confirm the validity of the Arrhenius plot calculated. The confirmation experiments in a flask scale were carried out on conditions shown in Table 2 by means of an experimental equipment having a constitution shown in FIG. 9. FIG. 9 is an explanatory drawing for explaining an outline of the experimental equipment used for confirming the validity of the Arrhenius plot calculated.

The constitution of an experimental equipment 900 shown in FIG. 9 shall be briefly explained. The experimental equipment 900 is constituted by a flask 902 receiving therein a reaction liquid 901, a thermometer 903 for measuring a temperature of the reaction liquid 901 in the flask 902, a mantle heater 905 equipped with a thermocouple 904 for heating the flask 902 based on the temperature measured by the thermometer 903, a stirrer 906 for stirring the reaction liquid 901 in the flask 902, a N₂ gas introducing port 907 for introducing a N₂ gas into the flask 902, an exhaust port 908 for exhausting a gas in the flask 902 to the outside of the flask 902, a condenser 909 connected with the exhaust port 908 and cooling the gas exhausted from the exhaust port 908 to thereby condense prescribed components contained in the gas, a chiller 910 connected with the condenser 909 and cooling a coolant circulated in the condenser 909, a cold trap 911 for collecting a condensate condensed in the condenser 909, a vacuum meter 912 provided in the cold trap 911 and measuring a vacuum degree in the system of the experimental equipment 900 and a vacuum pump 914 connected with the cold trap 911 via a decompression valve and reducing a pressure in the system of the experimental equipment 900.

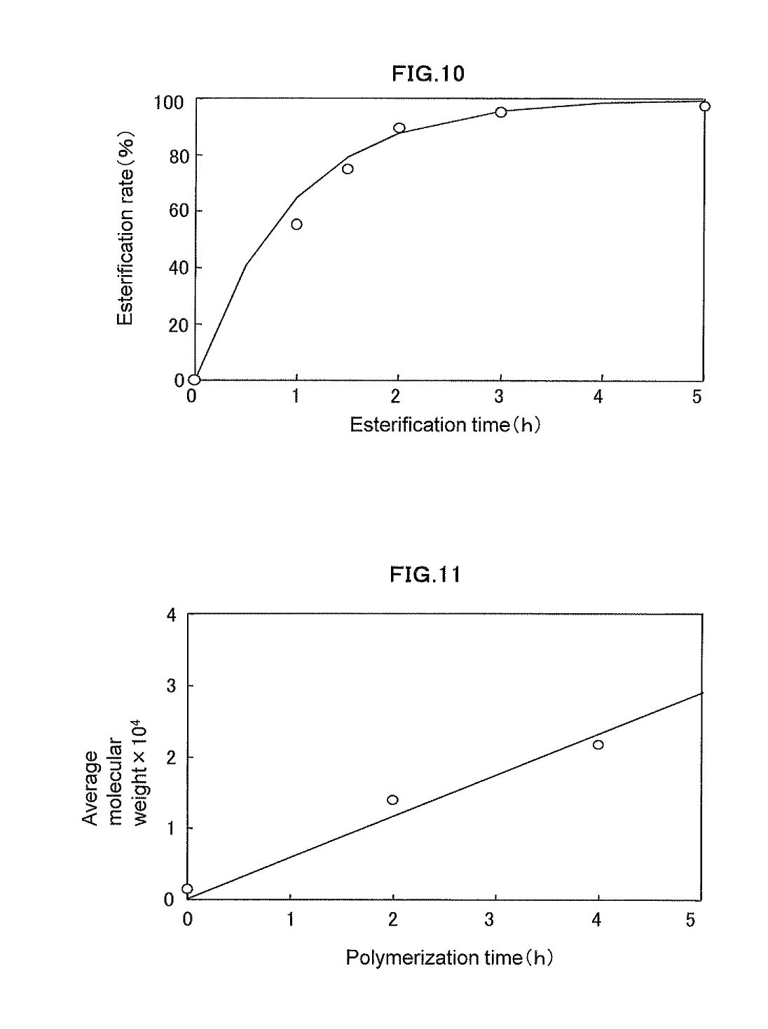

In the above confirmation experiments, an outlet of the condenser 909 was detached from the cold trap 911 and opened to the atmosphere. Also, in the present confirmation experiments, a sample was taken from the flask 902 after a reaction time shown in Table 2 passed, and an acid number thereof was obtained by titration to determine a change of the esterification rate with the passage of time. Then, the results obtained were compared with estimated values which could be calculated from Formula 12 to thereby confirm the validity of the Arrhenius plot. The result thereof is shown in FIG. 10. The confirmed results shall be described later. FIG. 10 is a graph showing the result obtained by confirming the validity of the Arrhenius plot regarding the esterification reaction of the polymer sample (PEF) formed in the condensation polymerization reaction carried out by using the titanium tetrabutoxide catalyst. In FIG. 10, a horizontal axis shows an esterification time (h), and a vertical axis shows an esterification rate (%). Also, the solid line shows an estimated value obtained from the Arrhenius plot, and the circle marks (∘) show the measured values obtained by the confirmation experiments.

TABLE 2

| Items | Conditions | |
|---|---|---|
| EG/FDCA mole ratio | 3 | |
| FDCA addition amount | 100 | g |
| Temperature | 190° | C. |
| Reaction time | 4 | hours |
| Catalyst concentration | 5000 | ppm/FDCA |

### [2] Preparation of Arrhenius Plot and Confirmation Experiments Therefor in Condensation Polymerization Reaction:

First, an oligomer was synthesized by an esterification reaction carried out in a flask scale on conditions shown in Table 2, and condensation polymerization reaction experiments in a test tube scale were carried out at various temperatures by using the above oligomer to obtain a change of a molecular weight thereof with the passage of time. Then, the reaction speed constants in the condensation polymerization reaction were calculated from the results thereof (refer to FIG. 5) to obtain the Arrhenius plot of the condensation polymerization reaction by settling a dependency on temperature.

Next, one combination of the conditions of the condensation polymerization reaction was selected from the Arrhenius plot obtained, and experiments in a flask scale were carried out to obtain a change of the molecular weight with the passage of time and confirm an integrity thereof with theoretical forecast. The details thereof are described below.

The condensation polymerization reaction experiments in a test tube scale were carried out on conditions shown in Table 3, wherein the oligomer described above and the catalyst (titanium tetrabutoxide) which was supplementarily added if necessary were added to the test tube, and glass joints for a nitrogen supplying system (1 atm) having a valve and a discharge system of a by-product (EG) gas were mounted to an upper part of the test tube. A condenser and a cold trap were connected with the discharge system. Then, the test tube was inserted into a commercial block heater test equipment and heated at a temperature for time each shown in Table 3. The sample was recovered from the test tube after finishing heating, and prescribed analysis was carried out to analyze the data thereof, whereby the reaction speed constant in the condensation polymerization reaction was calculated. A chemical formula regarding the condensation polymerization reaction is shown in Formula 15.

TABLE 3

| Items | Conditions |
|---|---|
| Oligomer addition amount | 2 g |
| Pressure | 1 torr |
| Temperature | 170 to 190° C. |
| Reaction time | 0 to 2 hours |
| Catalyst concentration | 5000 to 20000 ppm/FDCA |

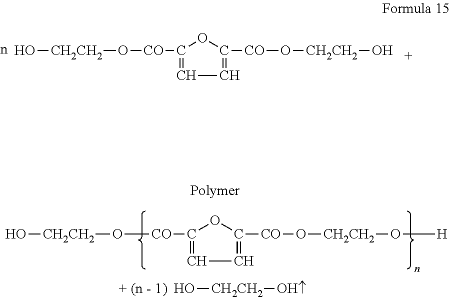

In analysis of the recovered sample, a molecular weight distribution thereof was measured by GPC (gel permeation chromatography) (detector Shodex RI-71+pump Shodex DS-4, manufactured by Showa Denko K.K.) to which a multiphoton dispersion system was applied. In the above case, hexafluoroisopropanol (HFIP) was selected as a solvent from the viewpoint of a solubility of the sample. After dissolving the sample in the solvent (concentration: 0.5 wt/vol %), the solution subjected to pre-treatment (filtrated through a filter of 0.2 μm) was injected (1 mL/minute) into a GPC column (Shodex GPC HFIP-806M×2+HFIP-803, manufactured by Showa Denko K.K., 40° C.), wherein correlation between a detection amount of the effluent and time was obtained, and it was compared with a correlational equation of a detection time and a molecular weight which was calculated from a detection time of a reference substance (PMMA, DMT), whereby a molecular weight distribution was determined.

The reaction shown in Formula 15 means that if hydroxyl groups at the ends of the oligomers are reacted, 2 mole of the oligomers are reduced, and assuming that the esterification rate in the initial reaction conditions is 100%, the following rate equation (Formula 16) on a hydroxyl group concentration [OH]ₜ is set up.

$$\frac{d {[ OH ]}_{t}}{d t} = - 2 {k [ OH ]}_{t}^{2} \qquad Formula 16$$

If the above equation is integrated in a duration of time t to t+^{Δt}, Formula 17 is obtained.

$$\frac{1}{{[ OH ]}_{t + Δ t}} - \frac{1}{{[ OH ]}_{t}} = 2 k \cdot Δ t \qquad Formula 17$$

The reaction speed constant k can be calculated from the above equation according to Formula 18.

$$k = \frac{1}{2 \cdot Δ t} ( \frac{1}{{[ OH ]}_{t + Δ t}} - \frac{1}{{[ OH ]}_{t}} ) \qquad Formula 18$$

On the other hand, an average polymerization degree of the polymer in time t is proportional to [OH]₀/[OH]ₜ. Accordingly, an average molecular weight M_{w,t} in time t has a relation of Formula 19 with a molecular weight of 182 in the polymer skeleton (=a molecular weight of EG+a molecular weight of FDCA−a molecular weight of two water molecules), an end group molecular weight correction value of 62 (=a molecular weight of EG), an initial value [OH]₀ of a hydroxyl group concentration and a value [OH]ₜ thereof in time t. According to the above relation, a value of k can be sequentially determined by calculating a hydroxyl group concentration from a value of the molecular weight obtained by GPC analysis.

M_{w,t}=182·[OH]₀/[OH]ₜ+62 Formula 19

Data included in the results obtained above were organized according to Formula 20 assuming that the reaction speed constant is proportional to the catalyst concentration as was the case with the esterification reaction.

Kₚ=k/[cat] Formula 20

The value of kₚ obtained was settled to 1/T to thereby prepare an Arrhenius plot, and the activation energy and the frequency factor were calculated from the values of a gradient obtained by a least square method and an intercept. T shows an absolute temperature (Kelvin (K)).

Confirmation experiments in a flask scale were carried out in order to confirm the validity of the Arrhenius plot calculated. The confirmation experiments in a flask scale were carried out on conditions shown in Table 4 by means of, as is the case with [1] described above, the experimental equipment 900 having a constitution shown in FIG. 9. In the present confirmation experiments, a sample was taken from the flask 902 after a reaction time shown in Table 4 passed and subjected to GPC analysis, and a change of a molecular weight thereof with the passage of time was determined. The results obtained were compared with estimated values which could be calculated from Formula 20 to thereby confirm the validity of the Arrhenius plot. The result thereof is shown in FIG. 11. FIG. 11 is a graph showing the result obtained by confirming the validity of the Arrhenius plot regarding the condensation polymerization reaction of the polymer sample (PEF) formed in the condensation polymerization reaction carried out by using the titanium tetrabutoxide catalyst. In FIG. 11, a horizontal axis shows a polymerization time (h), and a vertical axis shows an average molecular weight×10⁴. Also, the solid line shows an estimated value obtained from the Arrhenius plot, and the circle marks (∘) show the measured values obtained by the confirmation experiments.

TABLE 4

| Items | Conditions | |
|---|---|---|
| Oligomer addition amount | 100 | g |
| Pressure | 1 | torr |
| Temperature | 195° | C. |
| Reaction time | 4 | hours |
| Catalyst concentration | 20000 | ppm/FDCA |

### [3] Analysis of Coloring Cause:

In the various experiments on the bio-PET condensation polymerization described above, marked coloration of a dark red color has been confirmed in the polymers. It is known that usual polymer coloration is caused, as shown in Formula 21, by a double bond of a vinyl group formed by breakage (heat decomposition) of an ester bond in a principal chain due to a high heat history for a long time in a condensation polymerization step. Also, a heat decomposition reaction of a principal chain is expedited under the presence of an acid and an alkali, and therefore particularly a carboxyl group itself formed by a heat decomposition reaction accelerates heat decomposition in a certain case.

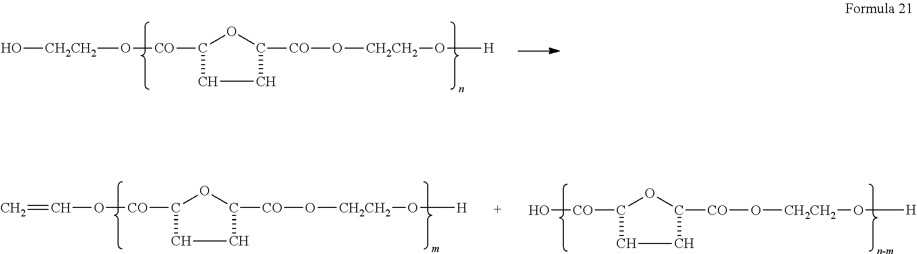

However, the bio PET reaction liquid is colored at a relatively low temperature of lower than 200° C., and the coloration proceeds quickly in a stage of an esterification reaction in which ester bonding does not necessarily sufficiently proceed. It is considered from the above fact that in the present experiments, subsidiary reactions caused in a stage of the esterification reaction are likely to participate in the cause of coloration, and the state of the oligomer was examined by NMR analysis carried out by means of ¹H- and ¹³C-NMR.

An apparatus used in the NMR analysis is CA-500FT-NMR (magnetic field strength: 11.747 T) manufactured by JEOL Ltd. The analysis by means of ¹H-NMR was carried out at room temperature and a frequency of 500 MHz in a ¹H nucleus by using deuterated trifluoroacetic acid as a solvent. Also, the analysis by means of ¹³C-NMR was carried out at room temperature and a frequency of 125 MHz in a ¹H nucleus by using deuterated dimethyl sulfoxide as a solvent. The oligomer sample used was synthesized in a flask on the conditions shown in Table 2.

### [4] Arrhenius Plot and Validity Thereof:

The Arrhenius plots regarding the esterification reaction and the condensation polymerization reaction and the results of the confirmation experiments therefor shall be explained with reference to FIG. 10 and FIG. 11. As described above, the results of the above confirmation experiments shown in FIG. 10 and FIG. 11 are shown in the form of a change in the esterification rate with the passage of time in a case of the esterification reaction and in the form of a change in the average molecular weight with the passage of time in a case of the condensation polymerization reaction, and they are shown by comparison thereof with the estimated lines obtained by the Arrhenius plots and the theoretical calculations.

The values of 184.3 kJ/mol and 4×10⁹ m³/mol·s·ppm in terms of the activation energy and the frequency factor in a case of the esterification reaction and the values of 163.4 kJ/mol and 8×10⁷ m³/mol·s·ppm in a case of the condensation polymerization reaction were obtained from the Arrhenius plots (refer to FIG. 4 and FIG. 5) respectively. The activation energies in the above reactions are notably large as compared with those (about 100 kJ/mol) in conventional polymers, and they are considered to have a very large temperature dependency.

On the other hand, changes in the esterification rate and the average molecular weight with the passage of time obtained by the confirmation experiments are consistent with the estimated lines (solid lines) obtained by the theoretical calculations, and it can be judged that the Arrhenius plots are valid. Also, it has been confirmed that the values of the esterification rate and the average molecular weight obtained by the confirmation experiments satisfy the targets of 95% and 20,000 or more respectively.

### [5] Coloring Cause:

As already explained, FIG. 2 shows the analytical result of the oligomer obtained by the ¹H-NMR analysis, and FIG. 3 shows the analytical result of the oligomer obtained by the ¹³C-NMR analysis.

In the ¹H-NMR analysis shown in FIG. 2, hydrogen atoms originating in a methylene group (—CH₂—) of EG contained in a fundamental skeleton of EG-FDCA and hydrogen atoms covalently bonded to carbon atoms present in 3- and 4-positions of FDCA are observed as principal peaks. In addition thereto, hydrogen atoms of a new methylene group originating in structures other than the fundamental skeleton are slightly observed in the above analysis.

On the other hand, in the ¹³C-NMR analysis shown in FIG. 3, carbon atoms originating in a methylene group (—CH₂—) of EG contained in the fundamental skeleton of EG-FDCA, carbon atoms present in 3- and 4-positions of FDCA, carbon atoms of 2- and 5-positions bonded to a carboxyl group and carbon atoms contained in a carboxyl group ester-bonded to EG are observed as principal peaks. In addition thereto, carbon atoms of a new carbonyl group originating in structures other than the fundamental skeleton are slightly observed in the above analysis. Among the compounds used in the experiments described above, only EG has a methylene group, and therefore it is estimated that the presence of a new methylene group suggests that EG is bonded in a form other than the fundamental skeleton, that is, in a form of a side chain. Also, in order to constitute a carbonyl group in the compounds used in the experiments described above, oxygen atoms bonded to carbon atoms are required. In a case of the experiments described above, a hydroxyl group present at an end of EG, a carboxyl group of FDCA and an oxygen atom of an ether bond are present as three kinds of oxygen atoms. Among them, a carboxyl group of FDCA is excluded since it is included in the fundamental skeleton, and it is estimated that a hydroxyl group present at an end of EG and an oxygen atom of the ether bond can take part in bonding of EG in a form of a side chain. It is estimated from the above matters that a cleavage reaction of the ether bond shown in Formula 22 is caused and that coloration is brought about due to a delocalized conjugate double bond formed by the above reaction.

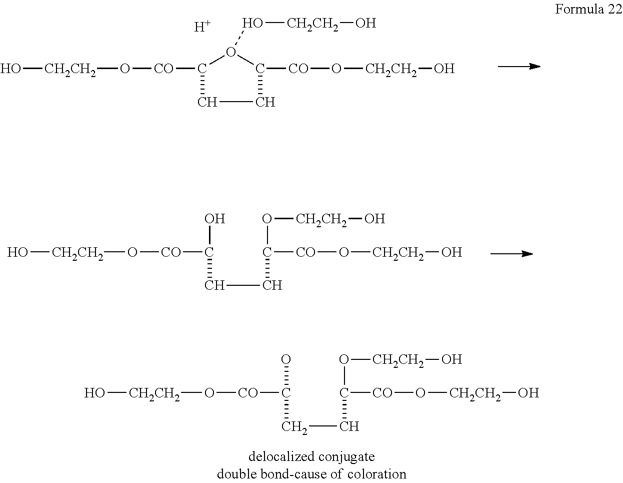

What is claimed is:

1. A polyester production process comprising:
an esterification step of carrying out an esterification reaction of ethylene glycol and 2,5-furandicarboxylic acid to form an oligomer and
a condensation polymerization step of carrying out a condensation polymerization reaction of the oligomer to produce a polyester, wherein the esterification reaction is carried out at 200 to 250° C.

2. The polyester production process as described in claim 1, wherein the esterification reaction is carried out on a condition of an atmospheric pressure or lower, and ethylene glycol volatilized in the esterification reaction is condensed and circulated to an esterification bath in which the esterification reaction is carried out.

3. The polyester production process as described in claim 1, wherein the esterification reaction is carried out on a pressurized condition.

4. The polyester production process as described in claim 1, wherein the condensation polymerization reaction is carried out at 215 to 250° C.

5. A polyester production apparatus comprising:
an esterification bath in which an esterification reaction of ethylene glycol and 2,5-furandicarboxylic acid is carried out to form an oligomer and
a condensation polymerization reactor in which a condensation polymerization reaction of the oligomer is carried out to produce a polyester, wherein the esterification reaction is carried out at 200 to 250° C.

6. The polyester production apparatus as described in claim 5, wherein a condensation circulation equipment in which volatilized ethylene glycol is condensed and circulated is provided in the esterification bath.

7. The polyester production apparatus as described in claim 5 or 6, wherein a pressure controlling equipment in which a pressure of an inside gas phase is controlled is provide in the esterification bath.
